(19) United States
(12) Patent Application Publication
(10) Pub. No.: US 2013/0199911 A1
(43) Pub. Date: Aug. 8, 2013

(54) MEMBRANE SWITCH UNIT AND KEYBOARD DEVICE INCLUDING THE MEMBRANE SWITCH UNIT

(71) Applicant: ALPS ELECTRIC CO., LTD., Tokyo (JP)

(72) Inventors: Shigenori SATO, Miyagi-ken (JP); Kunio HOSONO, Miyagi-ken (JP); Takenobu KIMURA, Miyagi-ken (JP); Katsuyuki KATAYAMA, Miyagi-ken (JP)

(73) Assignee: ALPS ELECTRIC CO., LTD., Tokyo (JP)

(21) Appl. No.: 13/737,854

(22) Filed: Jan. 9, 2013

(30) Foreign Application Priority Data
Feb. 2, 2012 (JP) 2012-021304

(51) Int. Cl. H01H 13/83

(52) U.S. Cl. CPC H01H 13/83
USPC 200/5 A

(57) ABSTRACT

In a membrane switch unit having an illumination function that is formed of a pair of sheets and has a plurality of light sources arranged therein, a plurality of fixed contacts having wiring portions are provided on a lower membrane sheet, a plurality of movable contacts formed independently of one another are formed on an upper membrane sheet, and a plurality of white LEDs (light sources) are provided on the upper membrane sheet where there is no wiring among the movable contacts. As a result, wiring paths can be freely provided and, hence, the plurality of the white LEDs connected in parallel with a power supply can be easily housed. Since the plurality of the white LEDs are connected in parallel with the power supply, the plurality of the white LEDs can be lit without using a voltage step-up circuit or a dedicated lighting power supply.

### CLAIM OF PRIORITY

This application claims benefit of Japanese Patent Application No. 2012-021304 filed on Feb. 2, 2012, which is hereby incorporated by reference.

### BACKGROUND OF THE INVENTION

1. Field of the Invention

The present invention relates to membrane switch units and keyboard devices including the membrane switch unit. In particular, the present invention relates to membrane switch units having an illumination function for illuminating operation keys and to keyboard devices including the membrane switch unit.

2. Description of the Related Art

Electronic apparatuses such as portable computers include a keyboard with which information such as alphanumerical characters is manually input by an operator. In general, the keyboard is formed of a plurality of key tops and a membrane switch unit.

The membrane switch unit includes a plurality of fixed contacts and movable contacts corresponding to key tops. When a user depresses a desired key top, a movable contact and a fixed contact corresponding to the depressed key top come into contact with each other, whereby a membrane switch corresponding to the key top is closed. As a result, an operation detection signal indicating that a key top has been depressed is transmitted from the membrane switch unit to a keyboard controller.

Recently, computers have become increasingly used for various purposes and in various environments. In particular, there are many cases in which portable computers are used in remote locations, where the computers may be used in an environment with insufficient illumination. In such a case, it is difficult for a user to recognize the key tops, which might cause an error in an operation.

Examples of related methods of solving the problem described above include a keyboard disclosed in Japanese Patent No. 4491033 in which key tops having transparency are used and the keyboard includes a light source for radiating light, a light guide allowing the light of the light source to pass therethrough, and a light diffusion board with a light diffusion portion that diffuses light passing through the light guide over a wide area, whereby the key tops are illuminated by light that is radiated from the light source.

### SUMMARY OF THE INVENTION

In a keyboard device used in a computer, since many key tops are arranged in a matrix, a plurality of light sources need to be provided to illuminate all the key tops even if, for example, a light diffusion board is used. Referring to FIG. 7, the related keyboard device disclosed in Japanese Patent No. 4491033 has a configuration in which a plurality of light sources 151 are arranged with spaces therebetween at one side of a first sheet 130 of a membrane sheet 129 that is formed of the first sheet 130 having fixed contacts 133 formed thereon and a second sheet 131 having movable contacts 135 formed thereon, whereby the entire membrane sheet 129 is illuminated. The positive electrodes of the plurality of the light sources 151 arranged in this manner are respectively connected to the negative electrodes of the neighboring light sources 151, whereby the plurality of the light sources 151 are connected in series with one another.

The configuration in which the plurality of the light sources 151 are connected in series with one another has an advantage in that minimum wiring is required for the light sources 151, and a conductor pattern 156 of the first sheet 130 can be easily formed even when the plurality of the light sources 151 are arranged on the first sheet 130, having a plurality of the fixed contacts 133 formed thereon, of the membrane sheet 129.

However, in the case where eight white LEDs are used as the light sources, lighting of the eight serially connected white LEDs requires a power supply having a voltage of at least eight times the forward drop voltage (usually about 3.5 volts or higher) of the white LED, i.e., a voltage of at least 28 volts.

Usually, a power supply of 28 volts is not connected to a keyboard device and, hence, a measure needs to be taken such as providing a voltage step-up circuit in the keyboard device or supplying the keyboard device with a power supply voltage specifically for lighting white LEDs. This configuration leads to an increase in the number of components and, hence, is difficult to put into practical use.

In view of the above-described situation, the present invention provides a membrane switch unit that does not require a voltage step-up circuit or a dedicated lighting power supply even when a plurality of light sources are arranged in the membrane switch unit.

To solve the above-described problems, in a membrane switch unit according to a first aspect of the present invention that has an illumination function and a plurality of light sources arranged therein, the membrane switch includes: a pair of sheets that are formed of an insulator and are arranged in such a manner as to face each other; and a plurality of contact portions each formed of a pair of contacts respectively formed on opposing surfaces of the pair of sheets. First contacts of the plurality of the contact portions are a plurality of fixed contacts formed of first fixed contacts and second fixed contacts provided on one sheet of the pair of sheets. Second contacts of the plurality of the contact portions are a plurality of movable contacts provided on the other sheet of the pair of sheets. The plurality of the movable contacts are arranged in such a manner as to contact the first fixed contacts and be able to come into and out of contact with the second fixed contacts of the plurality of the fixed contacts. The plurality of the movable contacts provided on the other sheet are formed independently of one another, and the plurality of the light sources are provided on the other sheet and are connected in parallel with a power supply.

With this configuration, since all of the plurality of the light sources are connected in parallel, the light sources can be lit using a low voltage and there is no need to provide a step-up circuit for stepping up a power supply voltage in the membrane switch unit. Further, since the plurality of the light sources are provided on the other sheet of the pair of sheets forming the membrane switch unit, where the plurality of the movable contacts are provided independently of one another and there is no wiring among the plurality of the movable contacts, wiring paths to the plurality of the light sources can be freely provided, whereby the plurality of the light sources can be easily built into the other membrane sheet.

As a result, even when the plurality of the light sources are arranged in the membrane switch unit, a membrane switch unit that does not require a voltage step-up circuit or a dedicated lighting power supply can be provided.

In the membrane switch unit, resistances of wiring lines respectively connecting the plurality of the light sources to the power supply are preferably respectively made to be current limiting resistances for the plurality of the light sources.

With this configuration, since resistances of wiring lines respectively connecting the plurality of the light sources to the power supply are preferably respectively made to be current limiting resistances of the plurality of the light sources, current limiting resistances for the respective light sources need not be provided in the membrane switch unit and, hence, arrangement of the light sources in the membrane switch unit is easy.

In the membrane switch unit, lengths and widths of the wiring lines respectively connected to the plurality of the light sources are preferably adjusted in accordance with respective positions of the plurality of the light sources.

With this configuration, the lengths and widths of the wiring lines respectively connected to the plurality of the light sources are preferably adjusted in accordance with the respective positions of the plurality of the light sources, whereby the respective total resistances of the wiring lines connected to the plurality of the light sources can be made to have desired values. Hence, currents flowing through the respective light sources can be set at desired levels without newly providing a plurality of resistors for limiting the currents respectively supplied to the light sources. As a result, a membrane switch unit can be provided in which the plurality of the key tops can be illuminated with uniform brightness using a simple structure.

In the membrane switch unit, wiring for a switch operation detection circuit of the membrane switch unit is preferably formed only on the one sheet.

With this configuration, since a configuration is employed in which the plurality of the fixed contacts each formed of the first fixed contact and the second fixed contact are provided on the one sheet of the pair of the sheets forming the membrane switch unit and the plurality of the movable contacts are provided independently of one another on the other sheet, and wiring for a switch operation detection circuit of the membrane switch unit is preferably formed only on the one sheet, wiring for the plurality of the light sources can be freely provided on the other sheet, whereby the degree of freedom of design is increased.

A keyboard device according to a second aspect of the present invention includes the membrane switch unit having an illumination function according to the first aspect of the present invention.

With this configuration, since the membrane switch unit having an illumination function according to the first aspect of the present invention is used, a keyboard device that does not require a voltage step-up circuit or a dedicated lighting power supply can be provided.

As described above, according to the present invention, a membrane switch unit that does not require a voltage step-up circuit or a dedicated lighting power supply can be provided even when a plurality of light sources are arranged in the membrane switch unit.

### BRIEF DESCRIPTION OF THE DRAWINGS

FIG. 1 is an exploded perspective view of the configuration of a keyboard device including a membrane switch unit of an embodiment;

FIG. 2 is an exploded perspective view of the configuration of the membrane switch unit of the embodiment;

FIGS. 3A to 3C are diagrams illustrating the configuration of the membrane switch of the embodiment, where FIG. 3A is a plan view of a movable contact, FIG. 3B is a plan view of a fixed contact, and FIG. 3C is a cross-sectional view of a multilayer body formed by stacking the fixed contact and the movable contact;

FIGS. 4A and 4B are diagrams describing the illumination structure of the membrane switch unit of the embodiment, where FIG. 4A is a plan view of the membrane switch unit and FIG. 4B is a sectional view taken along line IVB-IVB of FIG. 4A;

FIG. 5 is a detailed diagram for explaining the wiring state of white LEDs illustrating a portion of an upper membrane sheet to which the white LEDs are attached;

FIG. 6 is an external perspective view of a keyboard device of an embodiment; and

FIG. 7 is a diagram illustrating a membrane switch unit of a related example disclosed in Japanese Patent No. 4491033.

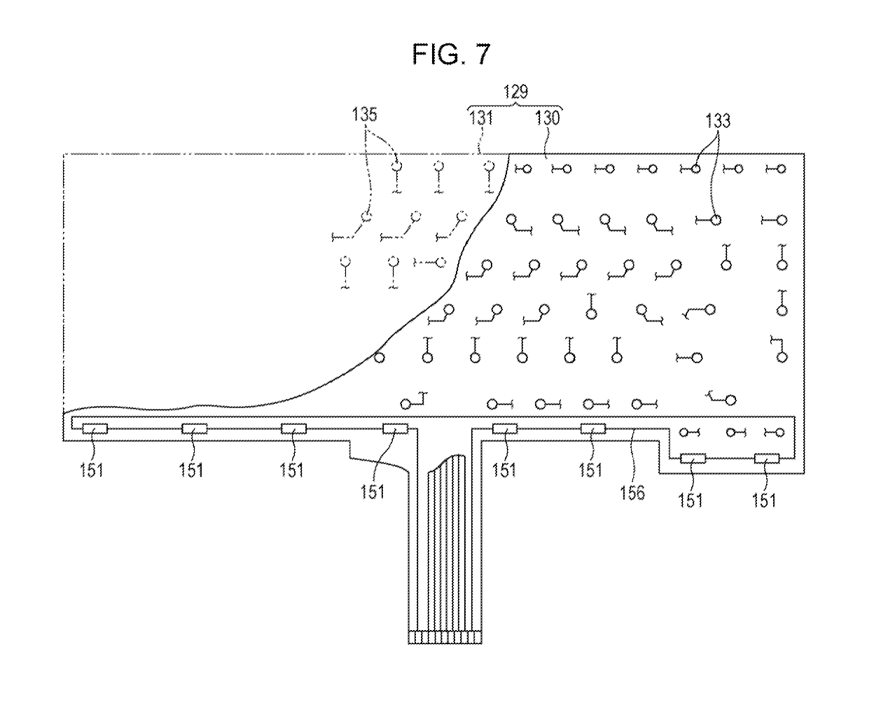

### DESCRIPTION OF THE PREFERRED EMBODIMENTS

### First Embodiment (Membrane Switch)

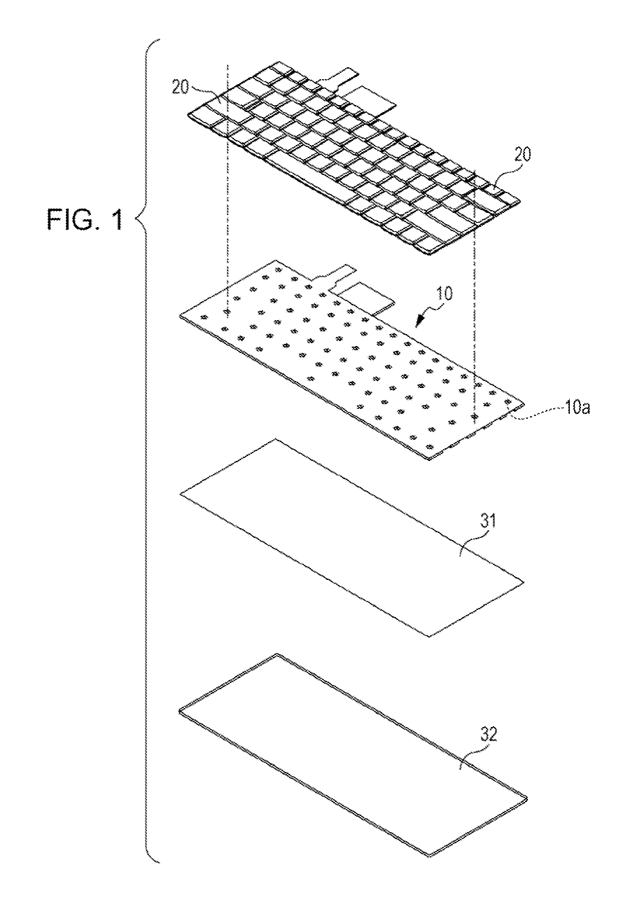

Hereinafter, a membrane switch unit 10 according to a first embodiment of the present invention will be described with reference to FIGS. 1, 2, and 3A to 3C.

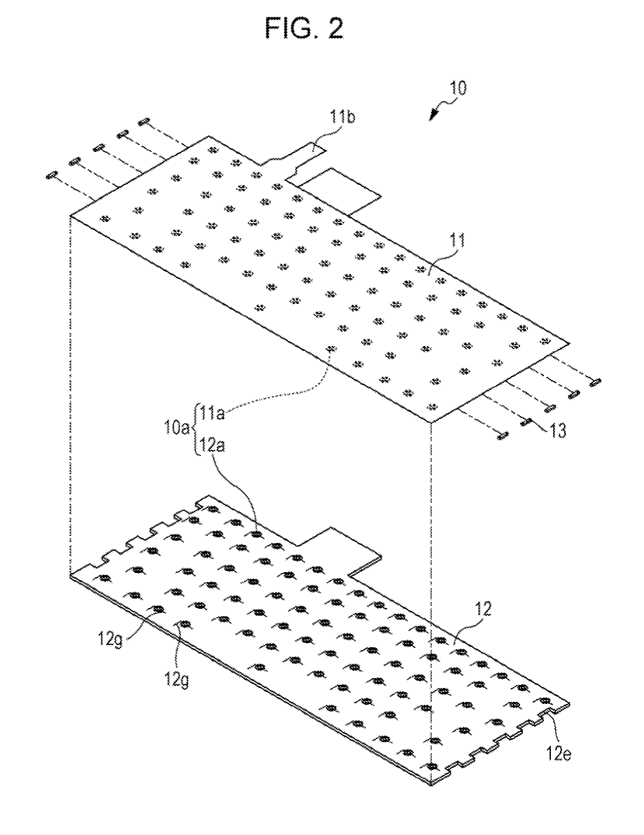

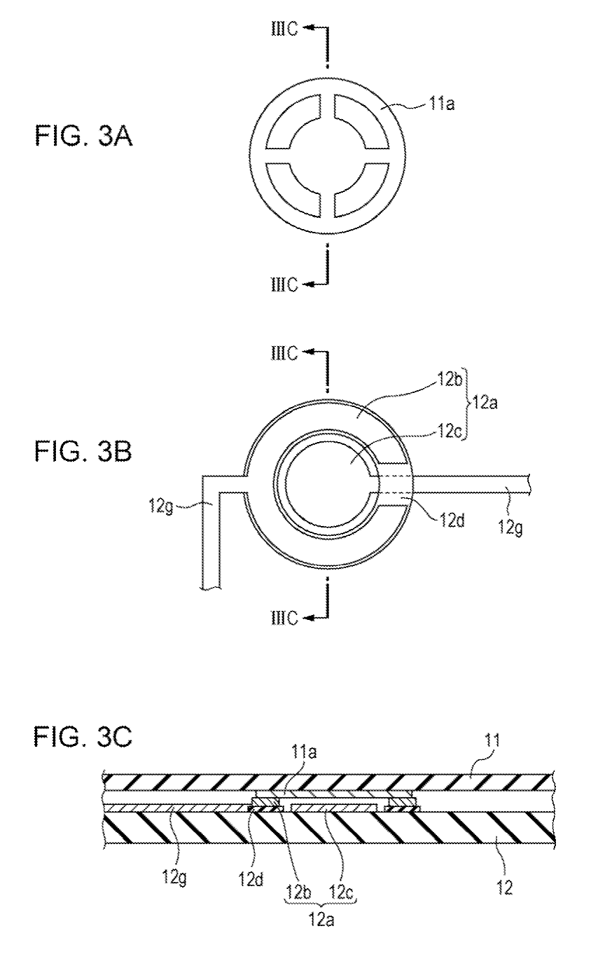

FIG. 1 is an exploded perspective view of the configuration of a keyboard device including the membrane switch unit 10 of the present embodiment. FIG. 2 is an exploded perspective view of the configuration of the membrane switch unit 10 of the present embodiment. FIGS. 3A to 3C are diagrams illustrating the configuration of a membrane switch 10a of the present embodiment. FIG. 3A is a plan view of a movable contact 11a, FIG. 3B is a plan view of a fixed contact 12a, and FIG. 3C is a cross-sectional view of a multilayer body formed by stacking the movable contact 11a on the fixed contact 12a, taken along cutting line IIIC-IIIC of the movable contact 11a illustrated in FIG. 3A and cutting line IIIC-IIIC of the fixed contact 12a illustrated in FIG. 3B.

Hereinafter, the membrane switch unit 10 according to the present embodiment of the invention will be mainly described regarding the membrane switch unit 10 used in a notebook personal computer. However, the application area of the membrane switch unit 10 according to the present embodiment is not limited to this and can be applied to keyboard devices used in various computers and electronic apparatuses.

Referring to FIG. 1, the membrane switch unit 10 according to the present embodiment of the invention is generally used in such a manner that a plurality of key tops 20 are arranged above the membrane switch unit 10 with an illumination member (not illustrated) therebetween and a reflection member 31 and a metal frame 32 are arranged below the membrane switch unit 10, whereby these components together form a keyboard device.

Note that although the present invention employs a configuration in which light propagates within the membrane switch unit 10, a configuration may be used in which a light guide is separately provided, as will be described later.

Referring to FIG. 2, the configuration of the membrane switch unit 10 will now be described.

The membrane switch unit 10 is formed of a flexible upper membrane sheet 11 and a flexible lower membrane sheet 12 that are stacked in such a manner as to face each other. On the membrane switch unit 10, a plurality of membrane switches 10a are provided in such a manner as to correspond to the positions of the plurality of the key tops 20 (refer to FIG. 1) that are arranged above the membrane switch unit 10 with a member movable up and down (not illustrated) therebetween.

The upper membrane sheet 11 is made of an insulating film material formed in a substantially rectangular shape and has the movable contacts 11a of the plurality of the membrane switches 10a formed thereon. A plurality of white LEDs 13 that illuminate the plurality of the key tops 20 are arranged on the bottom surface of the upper membrane sheet 11 near the two short sides of the upper membrane sheet 11.

The lower membrane sheet 12 is made of an insulating film material formed in a substantially rectangular shape and has the fixed contacts 12a of the plurality of the membrane switches 10a formed thereon. Further, the lower membrane sheet 12 has a plurality of cut-out portions 12e at the two short sides thereof into which the plurality of the white LEDs 13 arranged on the upper membrane sheet 11 are inserted.

Referring now to FIGS. 3A to 3B, the configuration of the membrane switch 10a is described. The membrane switch 10a is formed of the movable contact 11a provided on the bottom surface of the upper membrane sheet 11 and the fixed contact 12a provided on the top surface of the lower membrane sheet 12.

Referring to FIG. 3A, the movable contact 11a has a substantially disc-shaped conductor portion at the center thereof and a ring-shaped conductor portion surrounding the disc-shaped conductor portion. The conductor portion at the center and the surrounding conductor portion are connected to each other by a substantially cross-shaped conductor portion.

Referring to FIG. 3B, the fixed contact 12a is formed of a substantially disc-shaped second fixed contact 12c provided at the center and a substantially ring-shaped first fixed contact 12b, a portion of which is open, arranged outside of the second fixed contact 12c.

Wiring portions 12g for connecting of the plurality of the membrane switches 10a in a predetermined manner are respectively connected to the first fixed contact 12b and the second fixed contact 12c. The wiring portion 12g connected to the second fixed contact 12c at the center extends to the outside of the fixed contact 12a through the open portion of the substantially ring-shaped first fixed contact 12b.

The steps of manufacturing the fixed contact 12a are as follows. First the second fixed contact 12c at the center and the wiring portion 12g connected to the second fixed contact 12c are formed and, next, an insulating ring 12d is formed. The insulating ring 12d is formed using, for example, insulating ink in the shape of a ring in such a manner as to have a smaller inner diameter than the first fixed contact 12b and a larger outer diameter than the first fixed contact 12b. After the insulating ring 12d has been formed, the first fixed contact 12b and the wiring portion 12g are formed in such a manner as to be layered on the top surface of the insulating ring 12d. As a result, the first fixed contact 12b becomes slightly higher than the second fixed contact 12c. Further, the wiring portions 12g are subjected to insulating processing, as described later, at the same time as the step of forming the insulating ring 12d, as required.

When the upper membrane sheet 11 and the lower membrane sheet 12 are stacked in such a manner as to face each other, the first fixed contact 12b of the fixed contact 12a comes in contact with the movable contact 11a, as illustrated in FIG. 3C. However, since the first fixed contact 12b is slightly higher than the second fixed contact 12c, the second fixed contact 12c of the fixed contact 12a and the movable contact 11a face each other in such a manner as to be slightly spaced apart from each other.

Usually, the membrane switch unit 10 is built into a keyboard device, and the plurality of the key tops 20 are arranged above the membrane switch unit 10 (refer to FIG. 1). When the key top 20 is depressed in a state where the membrane switch unit 10 has been built into the keyboard device, the movable contact 11a of the membrane switch 10a corresponding to the depressed key top 20 is depressed by the key top 20, whereby the movable contact 11a is elastically deformed. As a result, the second fixed contact 12c of the fixed contact 12a comes in contact with the movable contact 11a, and the first fixed contact 12b and the second fixed contact 12c of the fixed contact 12a enter a state of being electrically connected to each other through the movable contact 11a, whereby it can be detected that the key top 20 has been depressed.

As described above, when the key top 20 is depressed, the first fixed contact 12b and the second fixed contact 12c of the lower membrane sheet 12 are electrically connected to each other through the movable contact 11a of the upper membrane sheet 11, whereby the depression of the key top 20 is detected. As a result, all of the wiring for detecting the states of the contacts is provided on the lower membrane sheet 12 on which the fixed contacts 12a are formed, and the movable contacts 11a do not have wiring for connecting the movable contacts 11a to the outside. Hence, on the upper membrane sheet 11, only the movable contacts 11a are provided and wiring for the membrane switches 10a is not provided.

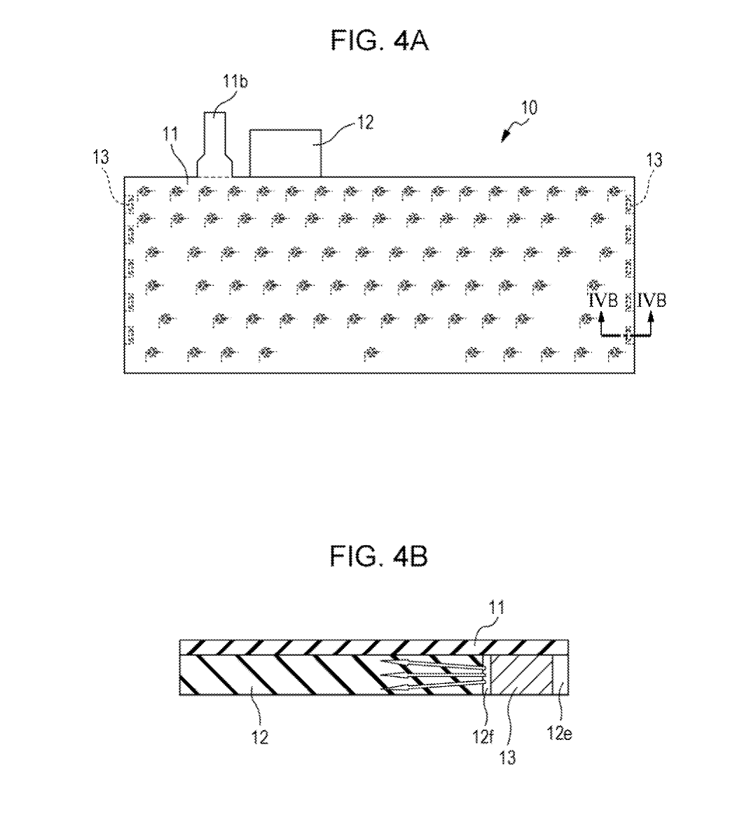

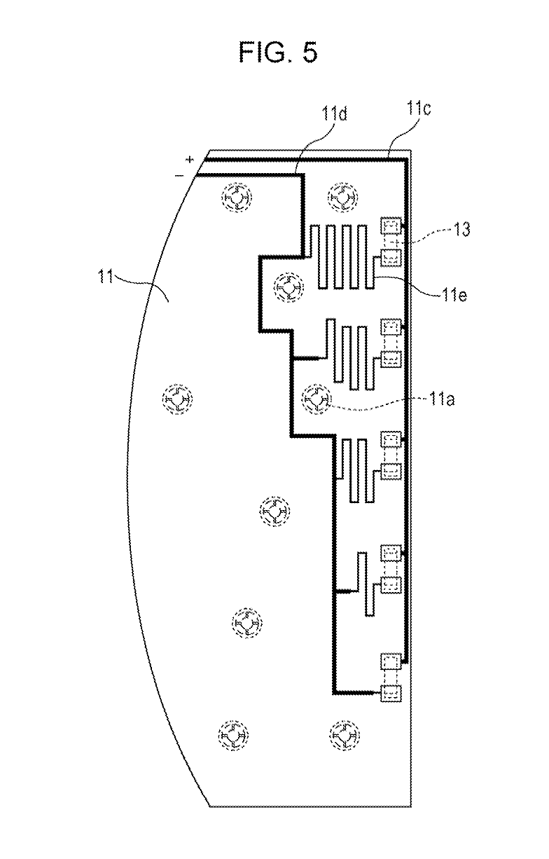

Referring to FIGS. 4A and 4B and FIG. 5, the illumination structure of the membrane switch unit 10 according to the present embodiment will now be described. FIGS. 4A and 4B are diagrams illustrating the illumination structure of the membrane switch unit 10 according to the present embodiment, where FIG. 4A is a plan view of the membrane switch unit and FIG. 4B is a sectional view taken along line IVB-IVB of FIG. 4A passing through the white LED 13. FIG. 5 is a detailed diagram illustrating a portion of the upper membrane sheet 11 to which the white LEDs 13 are attached, explaining the wiring state of the white LEDs 13.

Referring to FIG. 4A, the white LEDs 13 of the membrane switch unit 10 are respectively arranged in a plurality near the two short sides of a membrane sheet unit. The white LEDs 13 are attached to the bottom surface of the upper membrane sheet 11 and are inserted into the plurality of the cut-out portions 12e provided at the two short sides of the lower membrane sheet 12. As a result, the light emitting surfaces of the white LEDs 13 face end surfaces 12f of the cut-out portions, as illustrated in FIG. 4B. Light emitted from the light emitting surfaces of the white LEDs 13 enters the lower membrane sheet 12 from the end surfaces 12f of the cut-out portions, propagates through the lower membrane sheet 12, and expands throughout the lower membrane sheet 12. The light which has propagated through the lower membrane sheet 12 exits the top surface of the membrane switch unit 10 through diffusion grooves (not illustrated).

Note that the white LEDs 13 may be appropriately arranged, for example, near the four corner portions of the upper membrane sheet 11, rather than near the short sides of the upper membrane sheet 11. Further, although the present embodiment employs a structure in which light propagates through the lower membrane sheet 12, light guides or the like may be used instead.

Power supply wiring for the plurality of the white LEDs 13 is arranged on the bottom surface of the upper membrane sheet 11 and is formed of a pair of wiring lines consisting of a positive electrode wiring line 11c and a negative electrode wiring line 11d, as illustrated in FIG. 5. First ends of the positive electrode wiring line 11c and the negative electrode wiring line 11d extend to a connector portion 11b (refer to FIG. 2) of the upper membrane sheet 11. The second end of the positive electrode wiring line 11c is connected to all of the positive electrodes of the white LEDs 13 and the second end of the negative electrode wiring line 11d branches into meandering portions 13, which are respectively connected to the negative electrodes of the plurality of the white LEDs 13.

Note that in the case where the negative electrode wiring line 11d is arranged in such a manner as to surround the movable contacts 11a, when the upper membrane sheet 11 is stacked on the lower membrane sheet 12 (refer to FIG. 2), portions are formed where the positive electrode wiring line 11c or the negative electrode wiring line 11d intersects with the wiring portions 12g of the lower membrane sheet 12 (refer to FIG. 2). Since insulation is required at the portions where the positive electrode wiring line 11c or the negative electrode wiring line 11d intersects with the wiring portions 12g (refer to FIG. 2), insulating processing is performed on portions of the positive electrode wiring line 11c and the negative electrode wiring line 11d where they intersect with the wiring portions 12g (refer to FIG. 2) in the manufacturing step of forming the insulating ring 12d of the lower membrane sheet 12.

The shapes of the plurality of the meandering portions 11e that are respectively connected to the plurality of the white LEDs 13 are different from one another in accordance with the respective positions of the white LEDs 13. The meandering portion 11e arranged on the second end side of the positive electrode wiring line 11c or the negative electrode wiring line 11d, i.e., arranged at a position farthest from the connector portion 11b of the upper membrane sheet 11 is the shortest, and is substantially a simple straight wiring line. On the other hand, the meandering portion 11e connected to the white LED 13 arranged nearest to the connector portion 11b of the upper membrane sheet 11 is the longest. The meandering portions 11e connected to the white LEDs 13 arranged in the middle positions have a length that changes such that the shorter the distance between the white LED 13 and the connector portion 11b, the longer the length of the meandering portion 11e.

As a result, the total resistance of the positive electrode wiring line 11c, the negative electrode wiring line 11d, and the meandering portion 11e can be substantially made to have a predetermined constant value for all of the white LEDs 13, whereby all of the plurality of the white LEDs 13 can be lit at substantially the same current.

When the meandering portions 11e are provided between the negative electrode wiring line 11d and the white LEDs 13 as in the present embodiment, a wider area for wiring is required. However, in the present embodiment, only the movable contacts 11a of the contacts that form the membrane switches 10a are provided on the upper membrane sheet 11, and there is no wiring for connecting the movable contacts 11a to the outside. Hence, there is no wiring for the membrane switches 10a on the upper membrane sheet 11. As a result, wiring for connection of the white LEDs 13 can be freely provided on the upper membrane sheet 11 and, hence, the meandering portions 11e can be provided together with the positive electrode wiring line 11c and the negative electrode wiring line 11d for the plurality of the white LEDs 13.

As described above, the membrane switch unit 10 according to the present embodiment is configured as follows. In the membrane switch unit 10 having an illumination function that has a plurality of light sources arranged therein, the membrane switch unit 10 includes a pair of sheets consisting of the upper membrane sheet 11 and the lower membrane sheet 12, which are formed of an insulator and are arranged in such a manner as to face each other, and a plurality of the membrane switches 10a (contact portions) each formed of a pair of contacts respectively formed on the opposing surfaces of the pair of the sheets consisting of the upper membrane sheet 11 and the lower membrane sheet 12. First contacts of the plurality of the membrane switches 10a are the plurality of the fixed contacts 12a respectively formed of the first fixed contacts 12b and the second fixed contacts 12c provided on the lower membrane sheet 12 (one sheet) of the pair of the sheets consisting of the upper membrane sheet 11 and the lower membrane sheet 12. The second contacts of the plurality of the membrane switches 10a are the plurality of the movable contacts 11a provided on the upper membrane sheet 11 (the other sheet) of the pair of the sheets consisting of the upper membrane sheet 11 and the lower membrane sheet 12. The plurality of the movable contacts 11a are arranged in such a manner as to contact the first fixed contact 12b and be able to come into and out of contact with the second fixed contacts 12c of the plurality of the fixed contacts 12a. The plurality of the movable contacts 11a provided on the upper membrane sheet 11 are formed independently of one another, and the plurality of the white LEDs 13 (light sources) are provided on the upper membrane sheet 11 and are connected in parallel with a power supply.

In this manner, in the membrane switch unit 10 according to the present embodiment, since all of the plurality of the white LEDs 13 are connected in parallel, the white LEDs 13 can be lit using a low voltage and there is no need to provide a step-up circuit for stepping up a power supply voltage in the membrane switch unit 10. Further, since the plurality of the white LEDs 13 are provided on the upper membrane sheet 11 of the pair of the upper membrane sheet 11 and the lower membrane sheet 12 forming the membrane switch unit 10, where the plurality of the movable contacts 11a are provided independently of one another and there is no wiring among the plurality of the movable contacts 11a, wiring paths to the plurality of the white LEDs 13 can be freely provided, whereby the plurality of the white LEDs 13 can be easily built into the upper membrane sheet 11.

As a result, in the membrane switch unit 10 according to the present embodiment, even when the plurality of the white LEDs 13 are arranged in the membrane switch unit 10, a voltage step-up circuit or a dedicated lighting power supply is not required.

In the membrane switch unit 10 according to the present embodiment, since resistances of wiring lines respectively connecting the plurality of the white LEDs 13 (light sources) to the power supply are preferably respectively made to be current limiting resistances of the plurality of the white LEDs 13, current limiting resistances for the respective white LEDs 13 need not be provided in the membrane switch unit 10 and, hence, arrangement of the white LEDs 13 in the membrane switch unit 10 is easy.

In the membrane switch unit 10 according to the present embodiment, the lengths and widths of the wiring lines respectively connected to the plurality of the white LEDs 13 (light sources) are preferably adjusted in accordance with the respective positions of the plurality of the white LEDs 13, whereby the respective total resistances of the wiring lines connected to the plurality of the white LEDs 13 can be made to have desired values. Hence, currents flowing through the respective white LEDs 13 can be set at desired levels without newly providing a plurality of resistors for limiting the currents respectively supplied to the white LEDs 13. This enables illumination of the plurality of the key tops 20 with uniform brightness using a simple structure.

In the membrane switch unit 10 according to the present embodiment, since wiring for a switch operation detection circuit of the membrane switch unit 10 is preferably formed only on the lower membrane sheet 12 (one sheet), wiring for the plurality of the white LEDs 13 (light sources) can be freely provided on the upper membrane sheet 11 (the other sheet).

As described above, according to the present embodiment, even when the plurality of the white LEDs 13 (light sources) are arranged in the membrane switch unit 10, the membrane switch unit 10 that does not require a voltage step-up circuit or a dedicated lighting power supply can be provided.

Note that the present invention is not limited to the above-described embodiment and various modifications are possible as described below, for example, within the technical scope of the present invention.

In the membrane switch unit 10 described above, although only the lengths of the meandering portions 11e are changed for ease of understanding, the widths of the meandering portions 11e, the width of the positive electrode wiring line 11c, and the width of the negative electrode wiring line 11d may also be changed to make the total resistances of the wiring lines be made to have desired values.

Although the meandering portions 11e are connected to the negative electrode wiring line 11d, the meandering portions 11e may be connected to the positive electrode wiring line 11c. Alternatively, the meandering portions 11e may be provided in both of the positive electrode wiring line 11c and the negative electrode wiring line 11d.

Although the light sources are the white LEDs 13 in the membrane switch unit 10 according to the above-described embodiment, the LEDs need not be white LEDs. Further, the light sources may not be LEDs.

Although, in the fixed contact 12a of the membrane switch unit 10 according to the above-described embodiment, the insulating ring 12d is formed substantially in the shape of a ring in such a manner as to have a smaller inner diameter than the first fixed contact 12b and a larger outer diameter than the first fixed contact 12b, the size of the insulating ring 12d may be appropriately changed.

### Second Embodiment (Keyboard Device)

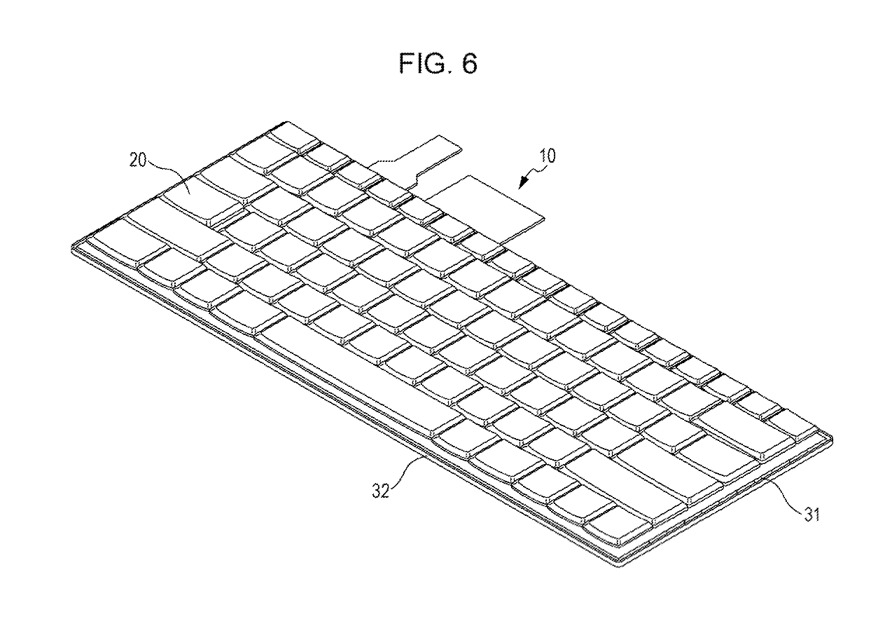

Hereinafter, a keyboard device according to a second embodiment of the present invention will be described with reference to FIG. 6.

FIG. 6 is an external perspective view of the keyboard device of the present embodiment.

The keyboard device of the present embodiment includes a plurality of key tops 20, a membrane switch unit 10, a reflection member 31, and a metal frame 32, and the membrane switch unit 10 having an illumination function according to the present invention is used as the membrane switch unit 10.

Since the membrane switch unit 10 having an illumination function according to the present invention is used in the keyboard device of the present embodiment, a keyboard device that does not require a voltage step-up circuit or a dedicated lighting power supply can be provided.

Note that the keyboard device according to the present invention is not limited to the above-described embodiment, and various modifications are possible within the technical scope of the present invention. For example, the reflection member 31 may be omitted or another sheet may be provided on the bottom surface of the metal frame 32.

1. A membrane switch unit having an illumination function, the membrane switch unit comprising:
a pair of sheets including a first sheet and a second sheet facing each other, the first and second sheets being formed of an insulating material;
a plurality of contact portions each formed of a pair of contacts each formed on a respective opposing surface of the first and second sheets, the plurality of the contact portions including:
a plurality of fixed contacts provided on the first sheet, each fixed contact being formed of a first fixed contact portion and a second fixed contact portion; and
a plurality of movable contacts provided on the second sheet, each movable contact being in contact with the first fixed contact portion of corresponding one of the plurality of the fixed contact, and being capable of coining into contact with and separating from the second fixed contact portion of the corresponding one of the plurality of the fixed contacts, the plurality of the movable contacts being formed independently of one another; and
a plurality of light sources provided on the second sheet and connected in parallel with a power supply.

2. The membrane switch unit having an illumination function according to claim 1, wherein each of the plurality of the light sources is connected to the power supply with a respective wiring line having a resistance, the resistance serving as a current limiting resistance for corresponding one of the plurality of the light sources.

3. The membrane switch unit having an illumination function according to claim 2, wherein a length and a width of each of the wiring lines are adjusted in accordance with a respective position of the corresponding one of the plurality of the light sources.

4. The membrane switch unit having an illumination function according to claim 1, further comprising:
a switch operation detection circuit of the membrane switch unit having a wiring therefor formed only on the first sheet.

5. A keyboard device comprising the membrane switch unit having an illumination function according to claim 1.

6. The membrane switch unit having an illumination function according to claim 1, wherein the first fixed contact portion is substantially ring-shaped with an opening, and the second fixes contact portion is substantially disc-shaped and surrounded by the first fixed contact portion.
